(19) United States
(12) Patent Application Publication
(10) Pub. No.: US 2017/0254625 A1
(43) Pub. Date: Sep. 7, 2017

(54) COMPOSITE BALLISTIC ARMOR

(71) Applicants: Peter J. Spransy, Salt Lake City, UT (US); Kamm Kartchner, Midway, UT (US)

(72) Inventors: Peter J. Spransy, Salt Lake City, UT (US); Kamm Kartchner, Midway, UT (US)

(73) Assignee: DAW Technologies, LLC, Salt Lake City, UT (US)

(21) Appl. No.: 15/450,242

(22) Filed: Mar. 6, 2017

Related U.S. Application Data
(60) Provisional application No. 62/304,828, filed on Mar. 7, 2016.

(51) Int. Cl. F41H 5/04; B32B 3/12; B32B 5/02; B32B 5/18; B32B 5/24; B32B 15/04; B32B 15/09; B32B 15/06; B32B 25/10; B32B 27/12; B32B 27/36; B32B 3/08; B32B 37/14; B32B 38/00; B32B 3/04

(52) U.S. Cl. CPC F41H 5/0464; B32B 3/04; B32B 3/12; B32B 5/024; B32B 5/18; B32B 5/245; B32B 15/046; B32B 15/09; B32B 15/06; B32B 25/10; B32B 27/12; B32B 27/36; B32B 3/08; B32B 37/146; B32B 37/142; B32B 38/0004; B32B 2255/10; B32B 2255/26; B32B 2260/021; B32B 2260/046; B32B 2262/101; B32B 2266/08; B32B 2307/558; B32B 2305/022; B32B 2305/024; B32B 2305/076; B32B 2305/08; B32B 2307/7246; B32B 2307/71; B32B 2311/30; B32B 2367/00; B32B 2319/00; B32B 2315/085; B32B 2571/02

(57) ABSTRACT

A composite ballistic panel provides cost-effective ballistic protection against projectiles. The composite ballistic panel comprises a composite ballistic assembly with an impact/strip layer that alters the projectile during striking contact with the projectile by flattening the projectile, distorting the shape of the projectile, reducing rotation of the projectile, reducing the velocity of the projectile, and inducing yaw to the projectile; a non-ballistic deflection layer that forms a cavity to inhibit propagation of the projectile's shock wave; and a containment layer that stops and captures the projectile within the composite ballistic assembly. Additionally, the composite ballistic panel may have a protection layer and a boundary edge to enhance capture of the projectile and ballistic characteristics, and an intermediate layer that acts as spacer between layers.

### RELATED APPLICATION

This patent application claims the benefit of U.S. Provisional Patent Application, Ser. No. 62/304,828 that was filed on Mar. 7, 2016, for an invention titled COMPOSITE BALLISTIC ARMOR, which is hereby incorporated herein by this reference.

### BACKGROUND OF THE INVENTION

1. Field of the Invention

The present invention relates to a composite ballistic panel for protecting against ballistic threats. More specifically, the present invention relates to a composite ballistic panel that provides light-weight, ballistic panel that captures and neutralizes ballistic threats received directly or obliquely.

Various exemplary embodiments of the present invention are described below. Use of the term “exemplary” means illustrative or by way of example only, and any reference herein to “the invention” is not intended to restrict or limit the invention to exact features or steps of any one or more of the exemplary embodiments disclosed in the present specification. References to “exemplary embodiment,” “one embodiment,” “an embodiment,” “some embodiments,” “various embodiments,” and the like, may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

2. The Relevant Technology

Law enforcement agencies, particularly SWAT teams, are often called upon to confront armed and dangerous individuals. It is not uncommon for these agencies to be facing 44 magnum or 9 mm handgun rounds, shotgun blasts, hunting rifles, and even assault rifles.

There exist numerous ballistic materials to protect law enforcement officers, soldiers, and the like, such bullet resistant soft body armor, bullet resistant hard armor, entry shields, and hard armor rifle plates for use with soft body armor, etc. The manufacturers of these various materials ostensibly apply an increase of their known technology when confronted by a greater threat. As an example, a manufacturer who uses Kevlar™ would simply use a greater thickness of Kevlar™, in additional layers as the anticipated threat increased. However, in such instances, little consideration is given to the added weight resulting from increasing the thickness of the ballistic material.

The goal of any adversary ultimately is to have the ability to defeat every ballistic panel and/or configuration he/she confronts. Various ballistic materials have weaknesses to certain types of ballistic threats. Such weaknesses typically are not remedied by merely increasing the thickness of the ballistic material. Hence, if an adversary can anticipate the nature of the ballistic materials he/she will likely confront, then weaponry may be chosen to defeat the ballistic material used.

Further, traditionally economical ballistic material is very heavy, whereas light-weight ballistic material (Kevlar™ for example) is very expensive. Also, the equipment costs required to manufacture some types of armor is cost prohibitive, and the equipment required to manufacture some types of armor is very specific making the development of new armor or incorporating new materials limiting.

Moreover, potential threats vary significantly. For example, the threats present in a military conflict are much different from those of a hostage situation, weapon wielding assailant, or protecting a celebrity or diplomat. The current technology for ballistic steel designed to stop a 30-06 (AP) round fired at fifty feet away, which is the N.I.J. Level IV threat would be approximately 0.5″ thick and weigh 20 pounds per square foot. A bullet striking a hardened steel panel from fifty feet is going to splatter and/or ricochet.

Accordingly, a need exists for a ballistic panel that provides ballistic protection against a broad range of ballistic threats being applied either directly or obliquely. Such a ballistic panel is disclosed herein.

### BRIEF SUMMARY OF THE INVENTION

The present disclosure describes developments responsive to the present state of the art, and in particular, in response to the problems and needs in the art that have not yet been fully solved by currently available ballistic shielding.

The exemplary embodiments of the present disclosure use composite panels comprised of polyester reinforced vinyl, ballistic FRP (fiberglass reinforced plastic), rubber and/or closed cell foam, hardened ballistic steel and steel bar stock. The exemplary combinations and arrangements of these materials provide ballistic protection against a broad range of ballistic threats.

Currently there are two rating systems for ballistic protection: 1) Underwriters' laboratory, (UL) and 2) The National Institute of Justice, (NIJ). The rating systems are not consistent between the two entities. The level of protection required for each confrontation can vary widely. However, the vast majority of active shooter situations, for example, are perpetrated using handguns and/or shotguns because these weapons can be easily concealed and carried into schools, colleges, public areas, etc.

The exemplary embodiments of the present disclosure are designed primarily to provide ballistic protection against various ballistic threats as defined by the National institute of Justice, (N.I.J.). Further, the exemplary embodiments are designed to also provide ballistic protection against IIIA and III+ threat levels as defined by the ballistic industry, i.e., shield manufacturers. Level IIIA and III+ are not recognized by N.I.J. but are colloquial terms in ballistic armor and are necessary levels of protection for ballistic armor.

Unlike most ballistic materials or panels, the exemplary embodiments of the present disclosure utilize ballistic and non-ballistic materials, each selected specifically for its unique attributes relative to the objective of defeating a supersonic or sub sonic projectile, or missile. In addition to stopping the ballistic threat, the exemplary combination of layers and the arrangement of each layer also mitigate ricochet and bullet splatter, both of which can be extremely dangerous to operators and innocent bystanders. The composite nature of this innovation also facilitates the increase or decrease of ballistic protection by the selection, thickness and arrangement of the materials identified, while limiting cost and weight. These exemplary ballistic composite panels and the unique manner in which they are assembled address ballistic threats in a manner not done by existing ballistic materials.

The exemplary embodiments of the present disclosure use various ballistic and non-ballistic materials, each selected specifically for its unique attributes relative to the purpose of defeating a supersonic or subsonic projectile, or missile etc. These exemplary ballistic composite panels and the manner in which they are assembled differ from existing ballistic materials by combining ballistic attributes into a composite panel that provides ballistic protection against a broad range of ballistic threats.

Each material comprising the exemplary ballistic panel is incorporated because of the unique properties it offers gauged against its weight, cost, and anticipated threat. There exist several actions that are necessary in the work of stopping a projectile; each layer is categorized relative to those actions They are:

1st . . . layer Protection layer (e.g., Vinyl coated polyester)

2nd layer . . . Impact/strip layer (e.g., Fiberglass Reinforced Plastic (FRP) panel)

3rd layer . . . Deflection layer (e.g., Rubber/closed cell foam)

4th layer . . . Containment layer (e.g., Hardened steel)

5th layer . . . Protection layer (e.g., Vinyl coated polyester)

6th boundary . . . Boundary edge (e.g., Steel bar stock)

The application of each type of layer described above and the configurations (combinations and permutations) of the ballistic panels could vary greatly depending upon cost constraints, desired weight requirements, the anticipated threat, and the desired characteristics for the ballistic panel. For this reason, it is appropriate to describe the individual properties of each material of the panel composition and how it is expected to perform. Various materials have been considered, including but not limited to, an impact/strip layer, a deflection layer, a containment layer, a protection layer, and a boundary edge.

In most embodiments, the impact/strip layer may comprise non-ballistic fiberglass reinforced plastic (FRP) and/or any suitable material that provides similar characteristics as FRP such as other resin-filled woven fibers. FRP is made in various grades and is commonly used for boat hulls. Lower grade FRP such as eglass is readily available and is suitable for use in an impact/strip layer because it tends to delaminate when impacted by a projectile such as a bullet or blast of shot. Higher grade FRP such as sglass is also suitable as an impact/strip layer, but it tends to be less available and is more expensive than eglass. However, since a relatively thin layer of FRP (e.g., about ⅛ inch) may be used as the impact/strip layer, depending on cost parameters, sglass may be used without the ballistic panel becoming cost prohibitive. In fact, in some embodiments, and by way of example, a thin layer of sglass sandwiched between thin layers of eglass may be used as an impact/strip layer to cost-effectively perform the desired characteristics of the impact/strip layer.

FRP is also made in various widths. For example, relatively thin FRP (i.e., less than ⅜ inch thick) is not considered to be ballistic. Thicker FRP has been used as a ballistic material as a stand-alone ballistic panel. Some thicknesses of FRP may be effective in stopping handgun rounds, but is highly inefficient at stopping high powered rifle fire. Generally, FRP is quite ineffective at stopping bullets having a steel core or a hardened steel (armor piercing) core.

In the present exemplary embodiments, FRP is used in a relatively thin layer (as thin as ⅛ inch). The purpose for this thin layer of non-ballistic FRP is not to stop the bullet, but rather to blunt and strip the outer layers of the bullet off. The hardness of the FRP strips away copper, and/or a metal jacket that is prevalent in most bullets exposing the softer lead core to then be “dragged” along with the projectile through the panel helping to reduce the velocity and defeat the intrusion. In some embodiments, the FRP material selected may be specially formulated to permit the layers of fiberglass roving to delaminate when struck by a projectile, thus absorbing some of the energy while continuing to flatten out the projectile and slowing its forward momentum. After the bullet passes through the FRP, because of the FRP's various delaminating layers, it tends to “self-heal” preventing the projectile from passing out of the hole it created. This self-healing is particularly important to inhibit ricochet. The variation of the material density resulting from the woven roving is expected to begin to flatten, or distort the shape of the projectile while also inducing yaw. The term yaw is meant to represent the disturbance of the ballistic rotation of the projectile resulting in the tumbling of the projectile. This tumbling dramatically reduces the projectile's penetrating capability.

Although the use of FRP as an impact/strip layer is particularly suitable in many embodiments, it should be understood that materials other than FRP that exhibit impact and/or stripping characteristics may also be used in an impact/strip layer. These other materials may be selected based on cost, weight, thickness, and type of likely threat considerations.

Exemplary deflection layers may comprise rubber, closed cell foam, a combination thereof, and/or any suitable material that provides similar characteristics as rubber or closed cell foam. This deflection layer may be placed abutting or subtending the impact/strip layer. When abutting, the deflection layer may permit the impact/strip to deflect into the deflection layer (move in the direction of the projectile) prior to beginning the delamination mentioned above. This momentary deflection maximizes the time the projectile is in contact with the primary (first) layer inducing the greatest possible amount of flattening, distortion and yaw of the projectile. In many instances, the deflection layer may form a cavity between the impact/strip layer and the containment layer. This cavity-forming feature creates space in which the projectile can yaw or tumble. In addition, the cavity formed prevents the shock wave of the projectile (which often produces most of the damage) from passing through the ballistic panel. Once the projectile has lost its ballistic rotation and begins to tumble, it has lost most of its penetrating power.

When the deflection layer subtends the impact/strip layer (i.e., it does not necessarily directly abut against the impact/strip layer), such as when an intermediate layer of air or some other material is placed between the deflection layer and the impact/strip layer, similar flattening, distortion and yaw effects may occur. For some embodiments, the non-ballistic intermediate layer serves as a spacer between layers and may comprise air, a non-ballistic honeycomb structure, bubble wrap, and other materials that provide spacing at little cost and without adding significant weight. Such spacing enhances the yaw effects. In other embodiments, the intermediate layer may comprise an adhesive to adhere the impact/strip layer to the deflection layer. Hence, the deflection layer need not necessarily abut directly against the impact/strip layer, but the relationship of these two layers may depend on cost, weight, and type of likely threat considerations. Exemplary deflection layers may also absorb a large amount of the initial impact of the projectile or missile.

Exemplary containment layers may comprise materials such as hardened steel or the like. The containment layer literally serves as the backstop of this ballistic panel composition. Once the bullet has been blunted, stripped, lost its ballistic rotation and is yawing at reduced velocity this layer catches all the remaining debris. The debris is still traveling at tremendous velocity; therefore, a hardened steel layer or other material capable of defeating the remaining threat is required.

There exist various levels of steel hardness that have been considered and there will yet be future developments in steel and other materials that may also have application as a containment layer. Abrasion resistant steel having a Brinell hardness of 500 (AR-500) is typically used in mining and construction to line the beds of dump trucks and other types of earth transporting vehicles. Such hardened steel is not considered ballistic and is readily available at prices well below the cost of ballistic steel, such as Mil-Spec AR-500 (expensive hardened steel specially made to be ballistic and to meet military specifications). In some embodiments, AR-500 and AR-550 (though less available) are suitable as a containment layer; however, AR-650, though much harder, is brittle and unsuitable because it may shatter upon first impact, thus being ineffective for multi-hit situations. Again, the type of hardened steel or other material (having backstop-like characteristics) may be selected as the containment layer based upon cost, weight, and type of likely threat considerations.

It should also be understood, that the containment layer may abut the deflection layer or the containment layer may subtend the deflection layer (i.e., the containment layer does not necessarily directly abut against the deflection layer), such as when an intermediate layer of air or some other material (e.g., a light-weight, inexpensive honey comb or bubble wrap) and the like is placed between the deflection layer and the containment layer. With this configuration, an intermediate layer may facilitate further flattening, distortion and yaw. In other embodiments, the intermediate layer may comprise an adhesive to adhere the containment layer to the deflection layer. Hence, the deflection layer need not necessarily abut directly against the containment layer, but the relationship of these two layers may depend on cost, weight, and type of likely threat considerations.

The exemplary protection layer may comprise vinyl coated polyester or any other suitable material such as polyuria or the like that is capable of performing the characteristics of the protection layer. Vinyl coated polyester is a fabric material that is typically utilized in tarp and boat cover manufacturing, and characteristically is an extremely tough polyester reinforced vinyl and is available in a range of colors. Of course, it should be understood that materials other than vinyl coated polyester may be suitable as a protection layer and may be selected as a protection layer based upon cost, weight, and type of likely threat considerations.

In exemplary embodiments of the protection layer, using the vinyl coated polyester protects the internal components (lower grade FRPs absorb moisture and non-ballistic hardened steels are susceptible to rust) from ultraviolet light (sun light) and moisture. Vinyl coated polyester has the added advantage of being strong enough to hold all the components together. Also, vinyl coated polyester and other vinyl materials may be cut in a pattern and solvent welded to form an “envelope” that may contain all of the component layers so that they may be handled as a single panel. The protective layer also provides an attractive appearance for the finished panels.

Additionally, the protection layer may conceal the location of shots to the panel. All ballistic panels are vulnerable to “shot on shot,” where a bullet hits in the same spot as a previous shot. Although the many exemplary embodiments of the present invention are rated as a multi-hit panel, if such panels are struck twice in the same place by a high powered rifle shot (i.e., a 30-06 armor piercing (AP) round), the bullet may fully penetrate the panel. To disguise (hide) where a previous shot has struck the panel is an advantage against a highly trained (sniper) threat. Consequently, certain suitable materials, including vinyl coated polyester, are better for disguising where the panel has been shot and may effectively thwart attempts to deliver a shot on shot assault on the panel.

The boundary edge, though not a layer, serves to capture a ricochet. A principal advantage to the exemplary embodiments of the present invention is the capability of capturing ricochets. It is reasonable to expect that a ballistic panel will stop a bullet for which it is rated; however, it is less clearly defined how the ballistic panel will perform when shot from an oblique angle. N.I.J. does not address ricochet, rather it defines ballistic levels by shots fired from zero obliquity, (90 degrees to the panel, in all directions). However, at some angles, projectiles can slide, or deflect off the armor, splatter or ricochet. Furthermore, projectiles that are successfully “stopped” by N.I.J standards but are permitted to ricochet or splatter may still produce some level of injury, resulting in severe bruising, broken bones, and possibly serious internal injury, even death. A panel having the benefit of stopping ricochet provides an advantage not previously known in the industry.

Exemplary embodiments of the boundary edge use steel strips (e.g., steel bar stock) disposed about the periphery of the panel along vulnerable edges of the panel. A bullet striking the panel at an oblique angle may pass through the impact/strip layer striking the containment layer and then skip through the cavity of the deflection layer to the edge of the panel to be captured at the boundary edge. Although strips of steel bar stock are suitable, it should be understood that other materials may work suitably to capture skip rounds, splatter, and ricochets. Again, the type of material used as the boundary edge may be selected based upon cost, weight, and type of likely threat considerations.

Although bonding the various components together is not required for any of the exemplary embodiments disclosed above, it has been considered that the materials used in at least some ballistic resistant composite panels could be bonded together for certain applications.

The exemplary embodiments of the present disclosure afford several advantages over existing ballistic systems. The components of most, if not all, of the exemplary embodiments may be selected so to be economically superior to present ballistic systems. The exemplary, non-bonded composite ballistic panels can easily be reconfigured as the known threat changes. The reduced weight of the exemplary panels makes them feasible to utilize in many applications against a broad range of threats. The exemplary composite ballistic panels capture ricochet bullets (projectiles), skip rounds and splatter. The exemplary panels are modular in nature and can be easily replaced following an “incident” where a panel has been compromised. The exemplary composite ballistic panels are easily constructed. The exemplary composite ballistic panels can easily employ new technologies (such as new, more cost-effective ballistic materials) as they are developed and become readily available at reasonable cost. Also, the exemplary composite ballistic panels do not require special manufacturing equipment.

These and other features of the exemplary responder shields of the present invention will become more fully apparent from the following description, or may be learned by the practice of the invention as set forth hereinafter.

### BRIEF DESCRIPTION OF THE DRAWINGS

The present invention is described more fully hereinafter with reference to the accompanying drawings, in which one or more exemplary embodiments of the invention are shown. Like numbers used herein refer to like elements throughout. This invention may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limiting the scope of the invention, which is to be given the full breadth of the appended claims and any and all equivalents thereof. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at least one of the items, but does not exclude a plurality of items of the list. Additionally, the terms “operator”, “user”, “officer”, “soldier”, and “individual” may be used interchangeably herein unless otherwise made clear from the context of the description.

Understanding that these drawing(s) depict only typical exemplary embodiments of the invention and are not therefore to be considered to be limiting of its scope, the invention will be described and explained with additional specificity and detail through the use of the accompanying drawings in which:

FIG. 1 is an exploded view of an exemplary composite ballistic panel showing the relative positions of each component;

FIG. 2 is the perspective view of the exemplary composite ballistic panel of FIG. 1 with a composite ballistic assembly staged for wrapping within an envelope of a protective layer; sheet];

FIG. 3 is a perspective view of the non-threat side of the fully-assembled, exemplary composite ballistic panel of FIG. 1 showing the wrap-around tabs in phantom lines disposed beneath the enveloping tab;

FIG. 4 is a perspective view of the threat side of the fully-assembled, exemplary composite ballistic panel of FIG. 1 showing the internal layers of the composite ballistic assembly and the wrap-around tabs in phantom lines;

FIG. 5 is a representative section view of the fully-assembled, exemplary composite ballistic panel of FIG. 1;

FIG. 6 is a perspective view of the threat side of an alternative, exemplary composite ballistic assembly with the protective layer removed so not to obscure the details of the composite ballistic assembly;

FIG. 7 is an exploded view of the alternative, exemplary composite assembly of FIG. 6;

FIG. 8 is a perspective view of the threat side of another alternative, exemplary composite ballistic assembly with the protective layer removed so not to obscure the details of the composite ballistic assembly;

FIG. 9 is an exploded view of the alternative, exemplary composite assembly of FIG. 8;

FIG. 10 is a representative section view of the alternative fully-assembled, exemplary composite ballistic panel of FIG. 8 with the protective layer shown;

FIG. 11 is an exploded view of yet another alternative, exemplary composite assembly having an intermediate layer of bubble wrap disposed between the deflection layer and the containment layer; and

FIG. 12 is a representative section view of the alternative fully-assembled, exemplary composite ballistic panel of FIG. 11 with the protective layer shown.

REFERENCE NUMERALS

| | |
|---|---|
| composite ballistic panel 10 | protection layer 12 |
| impact/strip layer 14 | deflection layer 16 |
| containment layer 18 | boundary edge 20 |
| composite ballistic assembly 22 | non-threat side 24 |
| threat side 26 | intermediate layer 28 |
| bubble wrap 30 | pattern 32 |
| staging area 34 | wrap-around tab 36 |
| enveloping tab 38 | periphery 40 |
| rear side 42 | |

### DETAILED DESCRIPTION OF THE INVENTION

The exemplary embodiments of the present disclosure will be best understood by reference to the drawings, wherein like parts are designated by like numerals throughout. It will be readily understood that the components of the exemplary embodiments of the present invention, as generally described and illustrated in the figures herein, could be arranged and designed in a wide variety of different configurations. Thus, the following more detailed description of the exemplary embodiments, as represented in the Figures, is not intended to limit the scope of the invention, as claimed, but is merely representative of exemplary embodiments of the disclosure.

In this application, the phrases “connected to”, “coupled to”, and “in communication with” refer to any form of interaction between two or more entities, including mechanical, capillary, electrical, magnetic, electromagnetic, pneumatic, hydraulic, fluidic, and thermal interactions.

The phrases “attached to”, “secured to”, and “mounted to” refer to a form of mechanical coupling that restricts relative translation or rotation between the attached, secured, or mounted objects, respectively. The phrase “slidably attached to” refer to a form of mechanical coupling that permits relative translation, respectively, while restricting other relative motions. The phrase “attached directly to” refers to a form of securement in which the secured items are in direct contact and retained in that state of securement.

The term “abut” and its formatives including “abutting” refers to items that are in direct physical contact with each other, although the items may not be attached together. The term “grip” refers to items that are in direct physical contact with one of the items firmly holding the other. The term “integrally formed” refers to a body that is manufactured as a single piece, without requiring the assembly of constituent elements. Multiple elements may be integrally formed with each other, when attached directly to each other from a single work piece. Thus, elements that are “coupled to” each other may be formed together as a single piece.

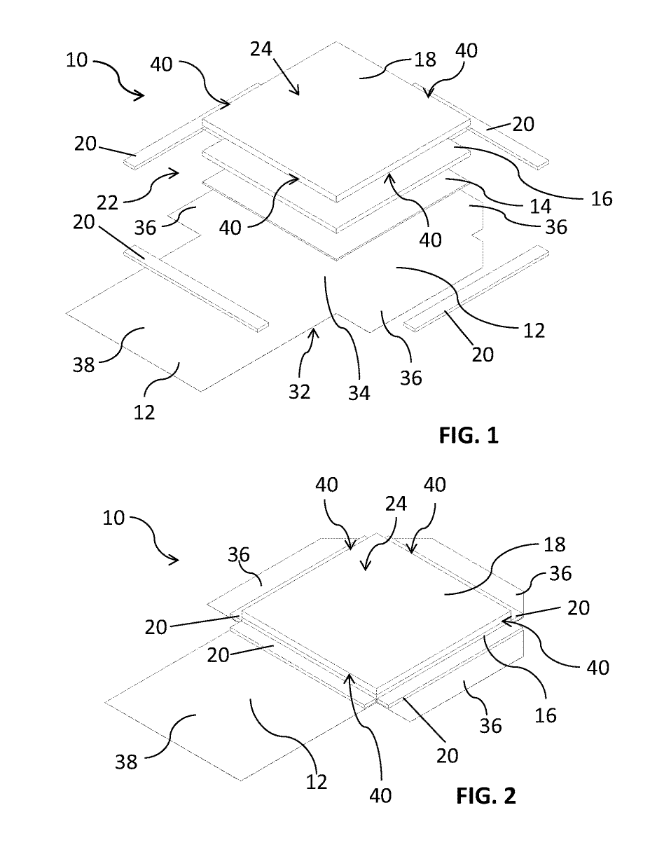

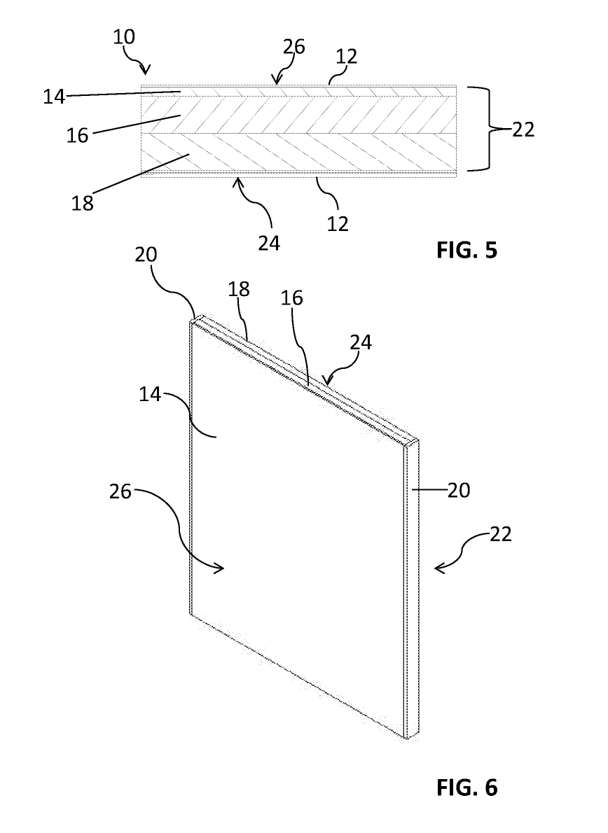

Turning first to FIGS. 1-5, an exemplary composite ballistic panel is depicted as composite ballistic panel 10. FIGS. 1-4 show an exemplary method for constructing the composite ballistic panel 10 and FIG. 5 is a representative section view of the fully-assembled composite ballistic panel 10 showing the relative positions of each component layer of the composite ballistic panel 10.

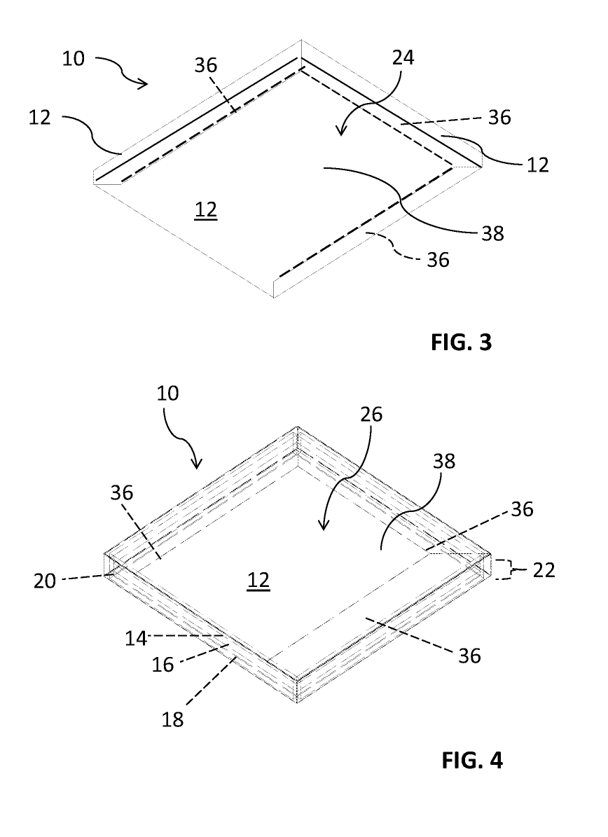

With this exemplary embodiment, the composite ballistic panel 10 comprises a protection layer 12, an impact/strip layer 14, a deflection layer 16, a containment layer 18, and at least one (in this case four) boundary edge 20, as best seen in the exploded view of FIG. 1. The protective layer 12 is used to envelop a composite ballistic assembly 22 comprising the impact/strip layer 14, the deflection layer 16, and the containment layer 18. In this exemplary embodiment, the composite ballistic assembly 22 further comprises four boundary edges 20. The protective layer 12 has the shape of an envelope blank for receiving the composite ballistic assembly 22 thereon. Each of the layer components; namely, impact/strip layer 14, the deflection layer 16, and the containment layer 18 have substantially the same front face and rear face dimensions, and when stacked and staged as shown in FIG. 2 are heavy enough to weigh down upon the protective layer 12 to inhibit slippage of the protective layer 12 during folding and securement of the enveloping protective layer 12 about the composite ballistic assembly 22. Also shown in FIG. 2 are the four, positioned and staged boundary edges 20 prior to folding the protective layer 12. FIG. 3 depicts a non-threat side 24 of the composite ballistic panel 10 after the protective layer has been folded about the composite ballistic assembly 22 forming an envelope that covers all surfaces of the composite ballistic assembly 22. FIG. 4 illustrates the threat side 26 of the composite ballistic panel 10 after the protective layer 12 has been folded about the composite ballistic assembly 22 forming an envelope that covers all surfaces of the composite ballistic assembly 22. The various component layers and folded edges of the protective layer 12 are shown in phantom lines to demonstrate that the relative positioning of the component layers do not change during the step of enveloping the composite ballistic assembly 22 and securing the protective layer 12 about the composite ballistic assembly 22.

FIG. 5 shows the relative positions of each component layer of the fully-assembled composite ballistic panel 10. In this exemplary embodiment, the composite ballistic panel 10 is arranged as follows:

1st layer . . . Protection layer (e.g., Vinyl coated polyester)

2nd layer . . . Impact/strip layer (e.g., Fiberglass Reinforced Plastic (FRP))

3rd layer . . . Deflection layer (e.g., Rubber/closed cell foam)

4th layer . . . Containment layer (e.g., Hardened steel)

5th layer . . . Protection layer (e.g., Vinyl coated polyester)

6th boundary . . . Boundary edge (e.g., Steel bar stock)

For purposes of description in this disclosure, the positioning of the layers will be described with the threat side 26 up (non-threat side 24 down) such that the 2^{nd} layer, the impact/strip layer 14, can be said to subtend the 1^{st} layer, the protection layer 12; the 3^{rd} layer, the deflection layer 16, subtends the 2^{nd} layer, the impact/strip layer 14, and so on.

When assembled as shown, the component layers of the composite ballistic assembly 22 provide ballistic protection using, in this exemplary embodiment, materials commonly thought of as non-ballistic. Rather, the ballistic protection is achieved using characteristics of the non-ballistic component layers so that a cost-effective ballistic panel results. In other exemplary embodiments, the application of each type of component layer listed above and the configurations (combinations and permutations) of the component layers may vary greatly depending upon cost constraints, desired weight requirements, the anticipated threat, and the desired characteristics for the composite ballistic panel 10. For this reason, it is appropriate to describe the individual properties of each material of the panel composition and how it is expected to perform. Various materials have been considered, including but not limited to, the impact/strip layer 14, the deflection layer 16, the containment layer 18, the protection layer 12, and boundary edges 20. It should be understood that in other embodiments and to achieve enhanced ballistic protection, one or more of the component layers may actually be made of ballistic material, provided the addition of the ballistic material meets any cost restraints.

In most embodiments, the impact/strip layer 14 may comprise non-ballistic fiberglass reinforced plastic (FRP) and/or any other suitable material that provides similar characteristics as FRP such as other resin-filled woven fibers. Because a relatively thin layer of FRP (e.g., about ⅛ inch) may be used as the impact/strip layer 14, cost and weight considerations are met. The purpose for this thin layer of non-ballistic FRP is not to stop the bullet or projectile, but rather to blunt and strip the outer layers of the bullet off. The hardness of the FRP strips away copper, and/or a metal jacket that is prevalent in most bullets exposing the softer lead core to then be “dragged” along with the projectile through the composite ballistic assembly 22 helping to reduce the velocity and defeat the intrusion. In some embodiments, the FRP material selected may be specially formulated to permit the layers of fiberglass roving to delaminate when struck by a projectile, thus absorbing some of the energy while continuing to flatten out the projectile and slowing its forward momentum. After the bullet passes through the FRP, because of the FRP's various delaminating layers, the FRP tends to “self-heal” preventing the projectile from passing out of the hole it created. This self-healing is particularly important to inhibit ricochet. The variation of the material density resulting from the woven roving is expected to begin to flatten, or distort the shape of the projectile while also inducing yaw that disturbs the ballistic rotation of the projectile resulting in the tumbling of the projectile. This tumbling dramatically reduces the projectile's penetrating capability.

Although the use of FRP as an impact/strip layer 14 is particularly suitable in many embodiments, it should be understood that materials other than FRP that exhibit impact and/or stripping characteristics may also be used in an impact/strip layer 14. These other materials may be selected based on cost, weight, thickness, and type of likely threat considerations.

Exemplary deflection layers 16 may comprise rubber, closed cell foam, a combination thereof, and/or any other suitable material that provides similar characteristics as rubber or closed cell foam. This deflection layer 16 may be placed abutting or subtending the impact/strip layer 14. When abutting as shown in FIG. 5, the deflection layer 16 may permit the impact/strip layer 14 to deflect into the deflection layer 16 (move in the direction of the projectile) prior to beginning the delamination of the impact/strip layer 14 mentioned above. This momentary deflection maximizes the time the projectile is in contact with the impact/strip layer 14 inducing the greatest possible amount of flattening, distortion and yaw of the projectile. In many instances, the deflection layer 16 may form a cavity between the impact/strip layer 14 and the containment layer 18. This cavity-forming feature creates space in which the projectile can yaw or tumble. In addition, the cavity formed prevents the shock wave of the projectile (which often produces most of the damage) from passing through the composite ballistic panel 10. Once the projectile has lost its ballistic rotation and begins to tumble, it has lost most of its penetrating power.

When the deflection layer 16 subtends the impact/strip layer 14 (i.e., it does not necessarily directly abut against the impact/strip layer), such as when an intermediate layer of air or some other material is placed between the deflection layer and the impact/strip layer, similar flattening, distortion and yaw effects may occur.

Exemplary containment layers 18 may comprise materials such as hardened steel or the like. The containment layer 18 literally serves as the backstop for the composite ballistic panel 10. Once the bullet has been blunted, stripped, lost its ballistic rotation and is yawing at reduced velocity the containment layer 18 catches all the remaining debris. The debris is still traveling at tremendous velocity; therefore, a hardened steel layer or other material capable of defeating the remaining threat is required.

There exist various levels of steel hardness that have been considered and there will yet be future developments in steel and other materials that may also have application as a containment layer. Abrasion resistant steel having a Brinell hardness of 500 (AR-500) is typically used in mining and construction to line the beds of dump trucks and other types of earth transporting vehicles. Such hardened steel is not considered ballistic and is readily available at prices well below the cost of ballistic steel, such as Mil-Spec AR-500 (expensive hardened steel specially made to be ballistic and to meet military specifications).

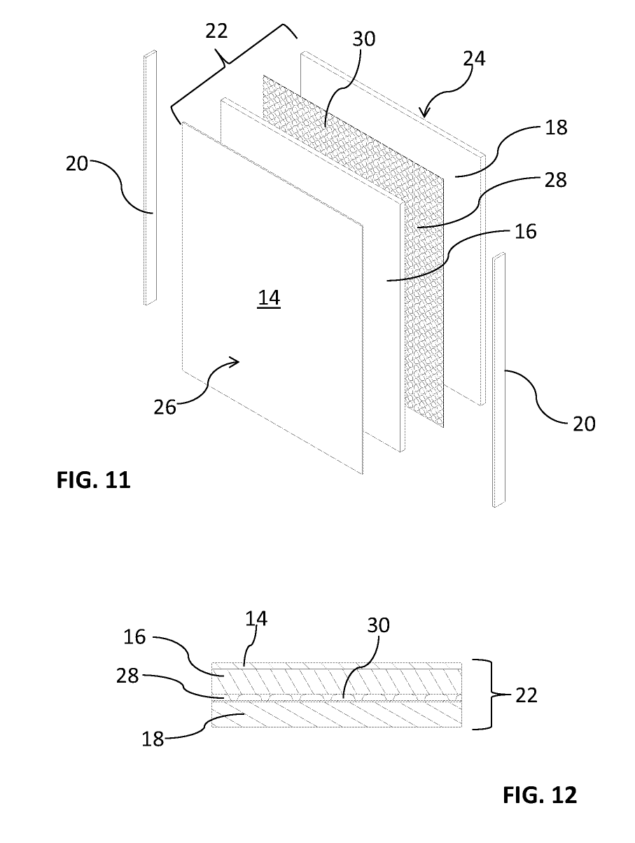

It should also be understood, that the containment layer 18 may abut against the deflection layer 16 (as shown in FIG. 5) or the containment layer 18 may subtend the deflection layer 16 (i.e., the containment layer 18 does not necessarily directly abut against the deflection layer 16), such as when an intermediate layer 28 of air or some other material (e.g., a light-weight, inexpensive honey comb or bubble wrap 30) and the like is placed between the deflection layer 16 and the containment layer 18 (as shown in FIGS. 11 and 12, that will be described below). With this configuration, an intermediate layer may facilitate further flattening, distortion and yaw. In other embodiments, the intermediate layer may comprise an adhesive to adhere the containment layer to the deflection layer. Hence, the deflection layer need not necessarily abut directly against the containment layer, but the relationship of these two layers may depend on cost, weight, and type of likely threat considerations.

The exemplary protection layer 12 may comprise vinyl coated polyester or any other suitable material such as polyurea or the like that is capable of performing the characteristics of the protection layer 12. Vinyl coated polyester is a fabric material that is typically utilized in tarp and boat cover manufacturing, and characteristically is an extremely tough polyester reinforced vinyl and is available in a range of colors. Of course, it should be understood that materials other than vinyl coated polyester may be suitable as a protection layer and may be selected as a protection layer based upon cost, weight, and type of likely threat considerations.

In exemplary embodiments of the protection layer 12, using the vinyl coated polyester protects the internal components (lower grade FRPs absorb moisture and non-ballistic hardened steels are susceptible to rust) from ultraviolet light (sun light) and moisture. Vinyl coated polyester has the added advantage of being strong enough to hold all the components together. Also, vinyl coated polyester and other vinyl materials may be cut in a pattern and solvent welded to form an “envelope” that may contain all of the component layers so that they may be handled as a single composite ballistic panel 10. The protective layer 12 also provides an attractive appearance for the finished composite ballistic panels 10.

Additionally, the protection layer 12 may conceal the location of shots to the composite ballistic panel 10. All presently known ballistic panels are vulnerable to “shot on shot,” where a bullet hits in the same spot as a previous shot. Although the many exemplary embodiments of the present invention are rated as a multi-hit panel, if such composite ballistic panels 10 are struck twice in the same place by a high powered rifle shot (i.e., a 30-06 armor piercing (AP) round), the bullet may fully penetrate the panel 10. To disguise (hide) where a previous shot has struck the threat side 26 of the composite ballistic panel 10 is an advantage against a highly trained (sniper) threat. Consequently, certain suitable materials, including vinyl coated polyester, are better for disguising where the composite ballistic panel 10 has been shot and may effectively thwart attempts to deliver a shot on shot assault on the composite ballistic panel 10.

As mentioned above, in exemplary embodiments of the protection layer 12, the protective layer 12 may be cut in a pattern and solvent welded to form an “envelope” that may contain all of the component layers for easy handling. An exemplary pattern 32 for the protective layer 12 is shown in FIGS. 1 and 2 and comprises a staging area 34 that corresponds to the reverse side of the threat side 26 for the composite ballistic panel 10, wrap-around tabs 36 and an enveloping tab 38. When staged as shown in FIG. 2, the weight of the composite ballistic assembly 22 inhibits the slipping of the protective layer 12 when pulling the wrap-around tabs 36 taut around the periphery 40 of the composite ballistic assembly 22. When pulled taut, each individual wrap-around tab 36 may be secured to the rear side 42 of the containment layer 18 by using a solvent adhesive or any other suitable means of securement.

Once the wrap-around tabs 36 are secured into place, the enveloping tab 38 may be pulled taut and position to cover the wrap-around tabs 36 and the remaining exposed rear side 42 of the containment layer 18. The enveloping tab 38 may be secured, much like sealing an envelope, by using a solvent adhesive or any other suitable means of securement. The solvent adhesive may be applied to secure the enveloping tab 38 in a number of ways; directly to the exposed wrap-around tabs 36, on the underside of the enveloping tab 38, either on just the areas that will contact the wrap-around tabs 38 or also on the area that will contact the rear side 42 of the containment layer 18, on the exposed rear side 42 of the containment layer, or any combination thereof.

The boundary edge 20, though not a layer, serves to capture a ricochet. A principal advantage to the exemplary embodiments of the present invention is the capability of capturing ricochets. It is reasonable to expect that a ballistic panel will stop a bullet for which it is rated; however, it is less clearly defined how the ballistic panel will perform when shot from an oblique angle. N.I.J. does not address ricochet, rather it defines ballistic levels by shots fired from zero obliquity, (90 degrees to the panel, in all directions). However, at some angles, projectiles can slide, or deflect off the armor, splatter or ricochet. Furthermore, projectiles that are successfully “stopped” by N.I.J standards but are permitted to ricochet or splatter may still produce some level of injury, resulting in severe bruising, broken bones, and possibly serious internal injury, even death. The exemplary composite ballistic panels 10 having the benefit of stopping ricochet provide an advantage not previously known in the industry.

Exemplary embodiments of the boundary edge use steel strips (e.g., steel bar stock) disposed about the periphery 40 of the composite ballistic assembly 22 along vulnerable edges of the composite ballistic panel 10. A bullet striking the threat side 26 of the composite ballistic panel 10 at an oblique angle may pass through the impact/strip layer 14 striking the containment layer 18 and then skip through the cavity of the deflection layer 16 to the edge of the composite ballistic assembly 22 to be captured at the boundary edge 20. Although strips of steel bar stock are suitable, it should be understood that other materials may work suitably to capture skip rounds, splatter, and ricochets. Again, the type of material used as the boundary edge may be selected based upon cost, weight, and type of likely threat considerations.

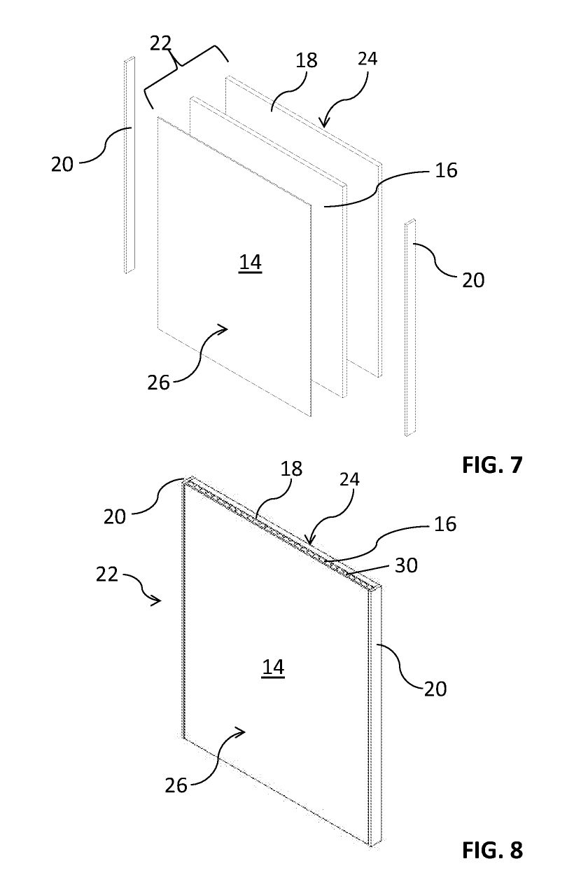

Although the embodiment of FIGS. 1-4 show the use of four boundary edges 20, it should be understood that the boundary edges 20 are used principally to capture skip rounds, splatter, and ricochets. Therefore, if the composite ballistic panel 10 is being used, such as part of a modular bunker system, where skip rounds, splatter, and ricochets are not of any concern because the bunker system will handle them, then a boundary edge 20 is not required. Also, one or more boundary edges 20 may be used about the composite ballistic assembly 22 adjacent only those portions of the periphery 40 that may pose a concern for skip rounds, splatter, or ricochets (shown best in FIGS. 6 and 7, illustrating a two boundary edge 20 embodiment).

Although bonding the various components together is not required for any of the exemplary embodiments disclosed above, it has been considered that the materials used in at least some ballistic resistant composite panels 10 could be bonded together for certain applications. Additionally, some bonding agents may provide added ballistic characteristics even though the bonding agents may be non-ballistic.

The exemplary embodiments of the present disclosure afford several advantages over existing ballistic systems. The components of most, if not all, of the exemplary embodiments may be selected so to be economically superior to present ballistic systems. The exemplary, non-bonded composite ballistic panels 10 can easily be reconfigured as the known threat changes. The reduced weight of the exemplary composite ballistic panels 10 makes them feasible to utilize in many applications against a broad range of threats. The exemplary composite ballistic panels 10 capture ricochet, skip rounds, and splatter. The exemplary composite ballistic panels 10 are modular in nature and can be easily replaced following an “incident” where a panel 10 has been compromised. The exemplary composite ballistic panels 10 are easily constructed. The exemplary composite ballistic panels 10 can also easily employ new technologies (such as new, more cost-effective ballistic materials) as they are developed and become readily available at reasonable cost. Also, the exemplary composite ballistic panels 10 do not require special manufacturing equipment.

FIGS. 8-10 depict an alternative exemplary embodiment of the composite ballistic assembly 22 for a composite ballistic panel 10. In this alternative exemplary embodiment, the defection layer 16 comprises bubble wrap 30 that serves as the deflection layer 16 as well as a spacer between the impact/strip layer 14 and the containment layer 18. Again, this alternative exemplary embodiment depicts the use of two boundary edges 20 disposed adjacent selected portions of the periphery 40 of the composite ballistic assembly 22.

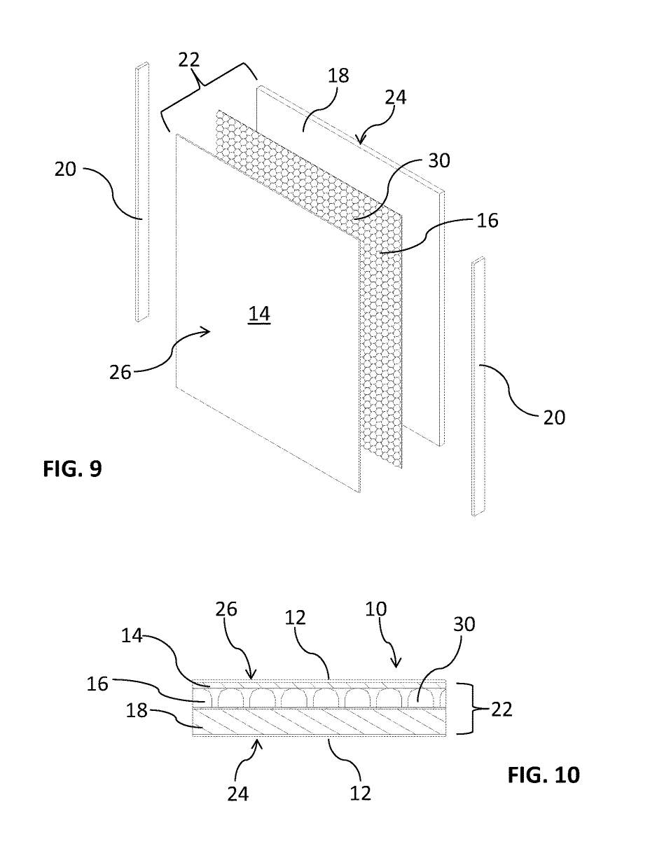

FIG. 10 is a representative section view of the alternative fully-assembled, exemplary composite ballistic panel 10 with the composite ballistic assembly 22 of FIGS. 8 and 9 with the protective layer 12 shown. The positioning of the layers shown with the threat side 26 up (non-threat side 24 down) illustrates that the 2^{nd} layer, the impact/strip layer 14, abuts and subtends the 1^{st} layer, the protection layer 12; the 3^{rd} layer, the deflection layer 16 which in this case is a layer of bubble wrap 30, subtends the 2^{nd} layer, the impact/strip layer 14; the containment layer 18 abuts and subtends the bubble wrap 30.

FIGS. 11 and 12 depict yet another alternative exemplary embodiment of the composite ballistic assembly 22 for a composite ballistic panel 10. In this alternative exemplary embodiment, the intermediate layer 28 comprises the bubble wrap 30 that serves as a spacer between the deflection layer 16 and the containment layer 18. The containment layer 18 subtends the deflection layer 16 with the intermediate layer 28 of bubble wrap 30 placed between the deflection layer 16 and the containment layer 18. With this configuration, the intermediate layer 28 facilitates further flattening, distortion, and yaw by providing additional space for the projectile to tumble and yaw before striking the containment layer 18, thus raising the ballistic aspects of the composite ballistic assembly 22 as against certain ballistic threats.

For some embodiments, the non-ballistic intermediate layer 18 serves as a spacer between layers and may comprise air, a non-ballistic honeycomb structure, bubble wrap 30, and other materials that provide spacing at little cost and without adding significant weight. Such spacing enhances the yaw effects.

In other embodiments, the intermediate layer 18 may comprise an adhesive to adhere the impact/strip layer 14 to the deflection layer 16. Hence, the deflection layer 16 need not necessarily abut directly against the impact/strip layer 14, but the relationship of these two layers may depend on cost, weight, and type of likely threat considerations. Exemplary deflection layers 16 may also absorb a large amount of the initial impact of the projectile or missile.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended as an affirmation that the invention has been previously reduced to practice or that any testing has been performed. Likewise, unless stated otherwise, use of verbs in the past tense (present perfect or preterit) is not intended to indicate or imply that the invention has been previously reduced to practice or that any testing has been performed.

Exemplary embodiments of the present invention are described above. No element, act, or instruction used in this description should be construed as important, necessary, critical, or essential to the invention unless explicitly described as such. Although only a few of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under Section 112, 6th paragraph is not intended. Additionally, it is not intended that the scope of patent protection afforded the present invention be defined by reading into any claim a limitation found herein that does not explicitly appear in the claim itself.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

Those skilled in the art will appreciate that the present embodiments may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A composite ballistic panel having a threat side for providing light-weight and cost-effective ballistic protection against projectiles striking the threat side and causing a shock wave, the composite ballistic panel comprising:
a composite ballistic assembly comprising:
an impact/strip layer comprising a first ballistic material, the impact/strip layer alters the projectile during contact of the projectile with the impact/strip layer, such altering of the projectile comprising at least one of flattening the projectile, distorting the shape of the projectile, reducing rotation of the projectile, reducing the velocity of the projectile, and inducing yaw to the projectile;
a deflection layer comprising a non-ballistic material, the deflection layer subtending the impact/strip layer such that the projectile striking the threat side contacts the impact/strip layer before the projectile contacts the deflection layer, the projectile striking the deflection layer causing the deflection layer to form a cavity, the cavity inhibiting the shock wave from passing through the composite ballistic panel; and
a containment layer having a threat face and comprising a second ballistic material, the deflection layer being disposed between the impact/strip layer and the containment layer, the containment layer capturing the projectile between the threat face and the threat side preventing the projectile from passage through the composite ballistic panel.

2. The composite ballistic panel of claim 1 further comprising a protection layer, the protection layer comprising a second non-ballistic material and being disposed to overlay at least a portion of the composite ballistic assembly to shield the composite ballistic assembly from exposure to light and moisture.

3. The composite ballistic panel of claim 2 wherein the protection layer is formed into an envelope for receiving therein the composite ballistic assembly.

4. The composite ballistic panel of claim 1 wherein the composite ballistic assembly has a periphery and the composite ballistic panel further comprises a boundary edge, the boundary edge being disposed adjacent to at least a portion of the periphery to retain the projectile within the composite ballistic assembly.

5. The composite ballistic panel of claim 1, wherein the deflection layer abuts against the impact/strip layer, whereby as the projectile strikes the impact/strip layer the deflection layer allows the impact/strip layer to deflect in the direction of the projectile thereby increasing the time the projectile remains in contact with the impact/strip layer.

6. The composite ballistic panel of claim 5 wherein the first ballistic material of the impact/strip layer comprises laminated layers and the deflection of the impact/strip layer begins before the laminated layers begin to delaminate.

7. The composite ballistic panel of claim 1 wherein the first ballistic material of the impact/strip layer comprises fiberglass reinforced plastic (FRP).

8. The composite ballistic panel of claim 1 wherein the non-ballistic material of the deflection layer comprises at least one of rubber, closed cell foam, and a gel.

9. The composite ballistic panel of claim 1 wherein the second ballistic material comprises hardened steel.

10. The composite ballistic panel of claim 1 wherein an intermediate layer is disposed between the impact/strip layer and the deflection layer.

11. The composite ballistic panel of claim 1 wherein an intermediate layer is disposed between the deflection layer and the containment layer.

12. The composite ballistic panel of claim 2 wherein the second non-ballistic material of the protective layer comprises a resilient material that inhibits determining where the projectile entered the composite ballistic panel.

13. The composite ballistic panel of claim 12 wherein the resilient material comprises vinyl coated polyester.

14. A composite ballistic panel having a threat side for providing cost-effective ballistic protection against projectiles striking the threat side and causing a shock wave, the composite ballistic panel comprising:
a composite ballistic assembly having a periphery and comprising:
an impact/strip layer comprising a first ballistic material, the impact/strip layer alters the projectile during contact of the projectile with the impact/strip layer, such altering of the projectile comprising at least one of flattening the projectile, distorting the shape of the projectile, reducing rotation of the projectile, reducing the velocity of the projectile, and inducing yaw to the projectile;
a deflection layer comprising a first non-ballistic material, the deflection layer subtending the impact/strip layer such that the projectile striking the threat side contacts the impact/strip layer before the projectile contacts the deflection layer, the projectile striking the deflection layer causing the deflection layer to form a cavity, the cavity inhibiting the shock wave from passing through the composite ballistic panel; and
a containment layer having a threat face and comprising a second ballistic material, the deflection layer being disposed between the impact/strip layer and the containment layer, the containment layer capturing the projectile between the threat face and the threat side preventing the projectile from passage through the composite ballistic panel;
a protection layer, the protection layer comprising a second non-ballistic material and being disposed to overlay at least a portion of the composite ballistic assembly to shield the composite ballistic assembly from exposure to light and moisture; and
a boundary edge, the boundary edge being disposed adjacent to at least a portion of the periphery to retain the projectile within the composite ballistic assembly.

15. The composite ballistic panel of claim 14 wherein the protection layer is formed into a sleeve for removably receiving therein at least one of the impact/strip layer, the deflection layer, and the containment layer from the composite ballistic assembly.

16. The composite ballistic panel of claim 15 wherein the protective layer is cut into a desired shape and edges of the protective layer are sealed to form the sleeve.

17. The composite ballistic panel of claim 14 wherein the boundary edge comprises steel bar stock.

18. A method for constructing a composite ballistic panel having a threat side for providing cost-effective ballistic protection against projectiles striking the threat side and causing a shock wave, the method comprising:
cutting a protective layer of non-ballistic material into a desired pattern, the pattern having a staging area, at least one wrap-around tab and an enveloping tab;
assembling a composite ballistic assembly having a non-threat side and a periphery by positioning an impact/strip layer shaped to fit upon the staging area together with a deflection layer shaped to fit upon the staging area and a containment layer shaped to fit upon the staging area in a configuration where the impact/strip layer is disposed toward the threat side;
staging the composite ballistic assembly on the staging area of the protective layer to secure the protective layer from slipping with respect to the composite ballistic assembly;
pulling the at least one wrap-around tab taut about the periphery of the composite ballistic assembly;
securing the tautly pulled at least one wrap-around tab to the non-threat side of the composite ballistic assembly;
pulling the enveloping tab about the periphery of the composite ballistic assembly to cover the none-threat side of the ballistic assembly; and
securing the tautly pulled enveloping tab to the non-threat side of the composite ballistic assembly.

19. The method of claim 18 further comprising the step of positioning a boundary edge adjacent to at least a portion of the periphery as part of the staging step.

20. The method of claim 18 further comprising the step of positioning an intermediate layer within the composite ballistic assembly.
